(19) United States
(12) Patent Application Publication
(10) Pub. No.: US 2011/0247981 A1
(43) Pub. Date: Oct. 13, 2011

(54) MIXED-MODE ADSORBENT MATERIAL

(76) Inventors: Tetsuyoshi Ono, Hitachinaka (JP); Yoshinori Inoue, Mitaka (JP)

(21) Appl. No.: 13/139,727

(22) PCT Filed: Dec. 11, 2009
(86) PCT No.: PCT/JP2009/070722

§ 371 Date: Jun. 14, 2011

(30) Foreign Application Priority Data
Dec. 15, 2008 (JP) 2008318893

(51) Int. Cl. B01D 15/04; C08F 220/56; C02F 1/42; B01J 39/20; B01J 41/14; G01N 30/00; C08F 220/32; C08F 8/30

(52) U.S. Cl. 210/662; 521/30; 521/31; 521/32; 428/402; 210/282; 210/660

(57) ABSTRACT

This invention provides an adsorbent material capable of effectively trapping a target component in a sample solution and releasing the same, which has the satisfactory trapping capacity via hydrophobic interactions and via ion exchange reactions. The invention relates to an adsorbent material comprising a porous material of a polymer compound which is a copolymer obtained via copolymerization of a hydrophobic monomer (A), a hydrophilic monomer (B) capable of undergoing a second-order reaction, and a hydrophilic monomer (C) exhibiting a hydrogen-bonding capacity, and via introduction of an ion exchange group into a repeat unit derived from the hydrophilic monomer (B).

### TECHNICAL FIELD

The present invention relates to an adsorbent material used for pretreatment of a sample and separation of a target component and a method for using such adsorbent material.

### BACKGROUND ART

Solid-phase extraction with the use of a solid-phase column for sample pretreatment and use of a reversed-phase column for sample separation are prevailing techniques. Conventional column-adsorbent materials are generally used in accordance with a single-mode mechanism, such as reversed-phase partition, ion exchange, or chelate trapping. With reversed-phase partition, a material of interest is trapped solely via hydrophobic interactions. Thus, such technique is not always effective for polar compounds comprising hydrophobic sites and ionic functional groups. With ion-exchange techniques, a target component in the sample is completely ionized, the resultant is subjected to an exchange reaction with an ionic component in the adsorbent material, and the target component is eluted via an additional exchange reaction. With ion-exchange techniques, accordingly, exchange reactions cannot be carried out under conditions in which the target component of a sample is completely ionized. Thus, it may occasionally be impossible to carry out a pretreatment of interest. In recent years, hydrophobic resins of column-adsorbing materials have been further provided with a secondary interaction capacity, such as hydrogen-bonding or ion exchange interaction capacity, so as to improve the capacity for trapping a polar compound.

The pore diameters of particles of adsorbent materials are generally 10 nm or less. In the case of highly viscous samples, such as organisms, food products, or processed food products, diffusion of target components inside the adsorbent material particles is insufficient, and efficient sample pretreatment is difficult. In addition, clogging takes place inside pores and among particles at the time of solid-phase extraction. Thus, it may occasionally be impossible to carried out pretreatment rapidly.

### PRIOR-ART DOCUMENT

[Patent Document 1] JP Patent Publication (toku-hyo) 2002-517574 A

### SUMMARY OF THE INVENTION

### Problems to be Solved by the Invention

Column-adsorbent materials prepared by merely improving trapping capacity occasionally require the use of large quantities of strong acids/organic solvents or strong bases/organic solvents in order to elute the target component, following trapping of the target component in the sample and removal of contaminants by washing to the greatest extent possible. Further, a target component may occasionally not be eluted.

When a highly hydrophobic adsorbent material, such as polystyrene gel is used, it is difficult in removing contaminants by washing to selectively wash off contaminants when the contaminants and the target components are highly hydrophobic.

When an ion exchange group is introduced into a highly hydrophobic functional group (i.e., divinylbenzene (DVB)), a strongly hydrophobic field is formed in the vicinity of hydrophobic DVB. Thus, the action of a hydrophilic (ionic) functionsal group is attenuated. Accordingly, it is difficult to effectively trap a highly hydrophilic (ionic) compound via dual-mixed-binding mode on each different two sites through hydrophobic and ion exchange reactions.

The present invention provides an adsorbent material having satisfactory trapping capacities via hydrophobic interactions and via ion-exchange reactions and capable of effectively trapping a target component in a sample solution and releasing the same.

### Means for Solving the Problems

The primary feature of the adsorbent material of the present invention is in that an ion exchange functional group is introduced into a hydrophilic monomer repeat unit instead of a hydrophobic monomer repeat unit of a porous adsorbent material comprising a copolymer of hydrophobic and hydrophilic monomers as a substrate. The present invention includes the following.

(1) An adsorbent material comprising a porous material of a polymer compound which is a copolymer obtained via copolymerization of a hydrophobic monomer (A), a hydrophilic monomer (B) capable of undergoing a second-order reaction, and a hydrophilic monomer (C) exhibiting a hydrogen-bonding capacity, and via introduction of an ion exchange group into a repeat unit derived from the hydrophilic monomer (B).

(2) The adsorbent material according to (1), which comprises an aromatic divinyl compound as the hydrophobic monomer (A) in an amount of at least 50% by mass based on the total amount of monomers.

(3) The adsorbent material according to (1) or (2), which comprises glycidyl methacrylate, glycerin methacrylate, 3-chloro-2-hydroxypropyl methacrylate, 2-hydroxyethyl methacrylate, or 2-chloroethyl methacrylate as the hydrophilic monomer (B) capable of undergoing a second-order reaction in an amount of 20% to 50% by mass based on the total amount of monomers.

(4) The adsorbent material according to (3), wherein the hydrophilic monomer (B) capable of undergoing a second-order reaction is glycidyl methacrylate.

(5) The adsorbent material according to any of (1) to (4), which comprises N,N-dimethylacrylamide, N,N-diethylacrylamide, or N-isopropylacrylamide as the hydrophilic monomer (C) exhibiting a hydrogen-bonding capacity in an amount of 5% to 10% by mass based on the total amount of monomers.

(6) The adsorbent material according to any of (1) to (5), wherein the average pore diameter of the porous material is 15 nm to 50 nm and the specific surface area is 100 to 500 m²/g.

(7) The adsorbent material according to any of (1) to (6), wherein the porous material has a particulate form and the average particle diameter is 3 μm to 100 μm.

(8) The adsorbent material according to any of (1) to (7), wherein the ion exchange group is a quaternary ammonium group introduced so that the ion exchange group amount is 0.3 to 0.8 meq, a secondary ammonium group introduced so that the ion exchange group amount is 0.7 to 1.5 meq, or a carboxyl group introduced so that the ion exchange group amount is 0.7 to 1.5 meq.

(9) An adsorbent material comprising a porous material having an average pore diameter of 15 nm to 50 nm and a specific surface area of 100 to 500 m²/g of a polymer compound which is a copolymer obtained via copolymerization of a hydrophobic monomer (A), a hydrophilic monomer (B) capable of undergoing a second-order reaction, and a hydrophilic monomer (C) exhibiting a hydrogen-bonding capacity, and via introduction of an ion exchange group into a repeat unit derived from the hydrophilic monomer (B).

(10) A solid-phase extraction cartridge comprising the adsorbent material according to any of (1) to (9) filled in a container.

(11) The solid-phase extraction cartridge according to (10), which is used for concentration of a target component and/or removal of contaminants.

(12) A method for treating a sample solution comprising performing solid-phase extraction or column switching with the use of the solid-phase extraction cartridge according to (10) or (11).

(13) A method for treating a sample solution containing a target component comprising bringing the sample solution containing a target component into contact with the adsorbent material according to any of (1) to (9) under conditions in which the target component is adsorbed to the adsorbent material to isolate, separate, fractionate, clean up, or remove the target component.

(14) A method for determining the amount of a target component in a sample solution comprising bringing the sample solution containing a target component into contact with the adsorbent material according to any of (1) to (9) under conditions in which the target component is adsorbed to the adsorbent material, washing the adsorbent material to which the target component had adsorbed under conditions in which the target component is released from the adsorbent material, and determining the amount of the target component in the solution resulting from the washing via an analytical technique.

(15) The method according to (13) or (14), wherein the adsorbent material according to any of (1) to (9) is used in the form of a solid-phase extraction cartridge filled in a container.

(16) The method according to any of (13) to (15), wherein the target component is a drug, agricultural chemical, herbicide, biomolecule, poison, contaminant, metabolite, or degraded product of any thereof.

(17) The method according to any of (13) to (16), wherein the sample solution is of blood, blood plasma, urine, spinal fluid, joint fluid, tissue extract, ground water, surface water, drinking water, soil extract, a food material, an extract of a food material, a plant extract, or an extract of a processed food.

This patent application claims priority from Japanese Patent Application No. 2008-318893 filed on Nov. 19, 2007, and includes part or all of the contents as disclosed in the description thereof.

### Effects of the Invention

The adsorbent material of the present invention has satisfactory trapping capacity achieved via hydrophobic interactions and via ion-exchange reactions. Thus, such adsorbent material is capable of effectively trapping a target component in a sample solution.

In addition, the amount of the solution used when eluting the target component from the adsorbent material of the present invention can be small. Thus, procedures for pretreatment of a sample solution, such as simultaneous concentration, clean up, and fractionation of a target component, required for HPLC and LC/MS analyses or separation of a target component from a sample solution can be easily and rapidly carried out.

### EMBODIMENTS FOR CARRYING OUT THE INVENTION

The adsorbent material of the present invention used for solid-phase extraction comprises a porous material of a polymer compound which is a copolymer obtained via copolymerization of a hydrophobic monomer (A), a hydrophilic monomer (B) capable of undergoing a second-order reaction, and a hydrophilic monomer (C) exhibiting a hydrogen-bonding capacity, and via introduction of an ion exchange group into a repeat unit derived from the hydrophilic monomer (B). The adsorbent material preferably consists of such porous material. Preferable embodiments of the present invention are described in detail below.

### 1. Hydrophobic Monomer (A)

In the present invention, the hydrophobic monomer (A) is not particularly limited, provided that it is capable of copolymerizing with the hydrophilic monomer (B) or (C). Such hydrophobic monomer is preferably an aromatic compound having a polymerizable double bond, and particularly preferably having two or more vinyl groups. Examples include divinyl benzene, divinyl toluene, divinyl xylene, divinyl naphthalene, and trivinyl naphthalene. Another hydrophobic monomer, such as styrene, may be used in combination with such hydrophobic monomer (A).

### 2. Hydrophilic Monomer (B)

In the present invention, the term “hydrophilic monomer (B) capable of undergoing a second-order reaction” refers to a monomer that is polymerizable with the hydrophobic monomer (A) or (C) having a reactive functional group uninvolved in copolymerization (e.g., an epoxy group) into which an ion exchange group can be introduced and capable of imparting hydrophilic properties. The term “second-order reaction” used herein refers to a reaction involving further introduction of an ion exchange group into the functional group after the copolymerization reaction. Examples of the hydrophilic monomer (B) include, but are not particularly limited to, glycidyl methacrylate, glycerin methacrylate, 3-chloro-2-hydroxypropyl methacrylate, 2-hydroxyethyl methacrylate, and 2-chloroethyl methacrylate, with glycidyl methacrylate being particularly preferable.

### 3. Hydrophilic Monomer (C)

Since the hydrophilic monomer (C) exhibits hydrogen-bonding capacity, such monomer is copolymerized for the purpose of causing interactions that are different from the hydrophilic interactions induced by the hydrophilic monomer (B) into which an ion exchange group has been introduced. The hydrophilic monomer (C) is not particularly limited, provided that such monomer is polymerizable with the hydrophobic monomer (A) and the hydrophilic monomer (B) and it is provided with a functional group having hydrogen-bonding capacity and uninvolved in copolymerization (e.g., an alkyl-substituted amide group). N,N-dimethylacrylamide, N,N-diethylacrylamide, and N-isopropylacrylamide are particularly preferable.

### 4. Mixing of Monomers

A copolymer preferably comprises the hydrophobic monomer (A) in an amount of 50% by mass or more, and particularly preferably 75% by mass or less, the hydrophilic monomer (B) capable of undergoing a second-order reaction in an amount of 20% to 50% by mass, and the hydrophilic monomer (C) exhibiting a hydrogen-bonding capacity in an amount of 5% to 10% by mass, based on the total amount of monomers.

The proportion by mass of the hydrophobic monomer (A) to the hydrophilic monomers (i.e., the hydrophilic monomer (B) capable of undergoing a second-order reaction and the hydrophilic monomer (C) exhibiting a hydrogen-bonding capacity (i.e., (B)+(C)) in the adsorbent material is preferably 1:1 to 3:1, more preferably 2:1 to 3:1, and most preferably 2:1.

### 5. Production of Copolymer

The adsorbent material of the present invention can be prepared by first forming a porous material via copolymerization of the monomers (A) to (C) and then introducing an ion exchange group into repeat units derived from the hydrophilic monomer (B) via chemical modification. A copolymer can be prepared in the following manner, for example.

Polymerization is preferably carried out by adding a diluent to a monomer mixture having a composition as described in 4. above, so as to impart porosity. As a diluent, an organic solvent that is dissolved in a monomer mixture, that is inactive in polymerization, and that does not dissolve the generated copolymer can be used. Examples include: aromatic hydrocarbons, such as toluene, xylene, ethylbenzene, and diethylbenzene; alcohols, such as hexanol, heptanol, and octanol; halogenated aromatic hydrocarbons, such as chlorobenzene and dichlorobenzene; and aliphatic or aromatic esters, such as ethyl acetate, butyl acetate, dimethyl phthalate, and diethyl phthalate.

Porous copolymer particles can be produced via suspension polymerization. A polymerization initiator is not particularly limited, provided that it is a known radical polymerization initiator that generates a radical. For example, an azo polymerization initiator, such as 2,2′-azobisisobutyronitrile or 2,2′-azobis(2,4-dimethylvaleronitrile), can be used.

A technique of suspension polymerization, which is carried out by stirring a monomer solvent comprising a diluent and a polymerization initiator in an aqueous medium comprising an adequate dispersion stabilizer, can be employed. A known dispersion stabilizer can be used, and examples thereof include water-soluble polymer compounds, such as gelatin, sodium polyacrylate, polyvinyl alcohol, methylcellulose, hydroxyethyl cellulose, and carboxymethyl cellulose.

Polymerization is preferably carried out by dissolving salts in an aqueous medium in order to inhibit dissolution of monomers in an aqueous medium. Examples of salts include sodium chloride, calcium chloride, and sodium sulfate.

Polymerization is preferably carried out with stirring at 40° C. to 100° C. at atmospheric pressure for 4 to 10 hours.

After the reaction, copolymer particles can be easily separated via filtration or other means, particles are thoroughly washed with water, and the diluent is removed with the use of a solvent, such as acetone or methanol, followed by drying.

The porous copolymer particles thus obtained typically have an average pore diameter of 15 to 50 nm, and preferably 20 to 40 nm, and a specific surface area of 100 to 500 m²/g, and preferably 200 to 300 m²/g. Since the adsorbent material of the present invention has a larger pore diameter than conventional adsorbent materials, such material is applicable to a highly viscous sample solution prepared from an organism, food product, processed food product, or the like.

The particle diameters of porous copolymer particles are not limited, and particles can be sorted in accordance with the purpose of use.

### 6. Introduction of Ion Exchange Group

The adsorbent material of the present invention can be prepared by allowing a compound capable of imparting an ion exchange group (R1) to react with a copolymer of the hydrophobic monomer (A), the hydrophilic monomer (B), and the hydrophilic monomer (C) (typically porous particles of the copolymer).

It is not necessary to introduce ion exchange groups into all the repeat units derived from the hydrophilic monomer (B). As long as the final form of a polymer compound has the desired absorption capacity, introduction of ion exchange groups into at least some of the repeat units is sufficient. It is preferable that a reactive group of the hydrophilic monomer (B) into which no ion exchange group is to be introduced be converted into a hydrophilic group, such as a hydroxyl group, in the step of introduction of an ion exchange group or subsequent steps.

The ion exchange group (R1) can be introduced into the hydrophilic monomer (B) via covalent bond formation in the following manner.

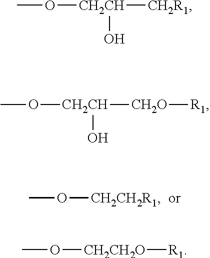

When the hydrophilic monomer (B) is a methacrylate compound, the left end of the construct preferably binds to carbonyl to form an ester.

An ion exchange group to be introduced is preferably a quaternary ammonium group, a secondary ammonium group, or a carboxyl group.

A quaternary ammonium group can be obtained by allowing a tertiary amine to react with an epoxy or chloro group of the hydrophilic monomer (B) capable of undergoing a second-order reaction. Examples of tertiary amines that can be used include trimethylamine, triethylamine, N,N-dimethylethylamine, N,N-dimethylethanolamine, N-methyldiethanolamine, and N,N-dimethylisopropanolamine. The amount of a quaternary ammonium group introduced is 0.3 to 0.8 meq/g, and preferably about 0.5 meq/g.

A secondary ammonium group can be obtained by allowing a primary amine to react with an epoxy or chloro group of the hydrophilic monomer (B) capable of undergoing a second-order reaction. As primary amines, polyamines, such as ethylenediamine, propylenediamine, or diethylenetriamine, can be used, in addition to aliphatic amines, such as methylamine, ethylamine, propylamine, or butylamine. The amount of a secondary ammonium group introduced is 0.7 to 1.5 meq, and preferably about 1.0 meq.

A carboxyl group that serves as a cation exchange group can be introduced by allowing monochloroacetic acid to react with a hydroxyl group of the hydrophilic monomer (B) capable of undergoing a second-order reaction or to react with a hydroxyl group after ring-opening of an epoxy group of the hydrophilic monomer (B) under alkaline conditions. Also, a carboxyl group can be introduced by allowing an acid anhydride to react with an epoxy group of the hydrophilic monomer (B) capable of undergoing a second-order reaction. Examples of acid anhydride that can be used include aliphatic polybasic acid anhydrides, such as succinic anhydride and malonic anhydride, and aromatic polybasic acid anhydrides, such as trimellitic acid anhydride and pyromellitic acid anhydride. The amount of a carboxyl group introduced is 0.7 to 1.5 meq, and preferably about 0.9 meq.

### 7. Applications

A container, such as a column, cartridge, or reservoir, may be filled with the adsorbent material of the present invention, and it may be used in the form of a solid-phase extraction cartridge. A solid-phase extraction cartridge is particularly appropriate for concentration of a target component and/or removal of contaminants.

Use of the adsorbent material of the present invention enables selective trapping and purification of a target component (i.e., a drug that is a polar compound) from a highly viscous sample solution containing complicated contaminants, such as organisms, food products, or processed food products (e.g., proteins, fats as non-polar substances, or amino acids) in a mixed mode. Since the amount of the eluate used for eluting the target component can be small, procedures for pretreatment of a sample solution, such as simultaneous concentration, clean up, and fractionation of a target component, required for HPLC and LC/MS analyses or separation of a target component from a sample solution can be easily and rapidly carried out.

Specifically, the adsorbent material of the present invention may be brought into contact with a sample solution containing a target component under conditions in which the target component is adsorbed on the adsorbent material. Thus, the target component can be isolated, separated, fractionated, cleaned up, or removed.

Also, the adsorbent material of the present invention may be brought into contact with a sample solution containing a target component under conditions in which the target component is adsorbed on the adsorbent material, the adsorbed target component is released via washing, and the target component released into the wash solution is then analyzed. Thus, the target component in the sample solution can be quantified.

### Example 1

### Synthesis of Substrate Resin Used for Introduction of Ion Exchange Group

Glycidyl methacrylate (600 g, Wako Pure Chemical Ind. Ltd., first-grade reagent), N,N-dimethylacrylamide (100 g, Wako Pure Chemical Ind. Ltd., special-grade reagent), and divinylbenzene (1,300 g, Nippon Steel Chemical Co., Ltd., purity: 57%) were measured. Isoamyl alcohol (1,200 g, Wako Pure Chemical Ind. Ltd., special-grade reagent) and n-butyl acetate (800 g, Wako Pure Chemical Ind. Ltd., first-grade reagent) were measured. These measured components were mixed with stirring. 2,2′-Azobis(isobutylonitrile) (20 g, Wako Pure Chemical Ind. Ltd., special-grade reagent) was added to the mixed solution and dissolved therein with stirring. Methylcellulose (25cP, 15 g) was dissolved in 15 liters of ion exchanged water to prepare a dispersion. These two types of solutions were introduced into a reaction vessel, particles were dispersed via stirring with a stirring impeller to attain the particle diameter distribution of interest, and polymerization was continued while maintaining temperature at 80° C. for 6 hours. After the completion of polymerization, the generated copolymer particles were separated by paper filtration and washed with ion exchanged water and methanol in such order, followed by drying. The obtained copolymer particles were sorted using a vibrating strainer of from 45 μm to 90 μm, and the resultant was designated as a substrate resin into which the ion exchange group would be introduced. As a control, a glycidyl group of the resulting substrate resin was ring-opened with the use of dilute sulfuric acid to synthesize a diol-type resin (EX1).

### (Introduction of Quaternary Ammonium Group: Synthesis of EX1-SAX)

The substrate resin (50 g) into which an ion exchange group would be introduced was introduced into a 500-ml flask equipped with an agitator, 200 ml of an aqueous solution of 20% isopropyl alcohol and 100 g of N,N-dimethylethanolamine were added thereto, and the reaction was allowed to proceed with agitation at 40° C. for 20 hours. After the reaction, the reaction product was separated by paper filtration, thoroughly washed with ion exchanged water, substituted for methanol, and then dried. The resulting particles into which the quaternary ammonium group had been introduced were subjected to back titration to measure the ion exchange capacity. As a result, the capacity of interest was found to be 0.51 meq/g.

### (Introduction of Secondary Ammonium Group: Synthesis of EX1-WAX)

A secondary ammonium group was introduced in completely the same manner as in the case of the introduction of quaternary ammonium group above, except that ethylenediamine was used instead of N,N-dimethylethanolamine. The resulting particles into which the secondary ammonium group had been introduced were subjected to back titration to measure the ion exchange capacity. As a result, the capacity of interest was found to be 0.95 meq/g.

### (Introduction of Carboxyl Group: Synthesis of EX1-WCX)

The adsorbent material particles (50 g) into which ion exchange groups would be introduced were introduced into a 500-ml flask equipped with an agitator, 60 g of trimellitic acid anhydride and 300 ml of dimethylformamide were added thereto, and the reaction was allowed to proceed with agitation at 60° C. for 20 hours. After the reaction, the reaction product was separated by paper filtration, thoroughly washed with dimethylformamide and ion exchanged water in such order, substituted for methanol, and then dried. The resulting particles into which the carboxyl group had been introduced were subjected to back titration to measure the ion exchange capacity. As a result, the capacity of interest was found to be 0.87 meq/g.

(Performance of Adsorbent Material after Introduction of Ion Exchange Group)

Table 1 shows basic physical properties of the adsorbent materials into which an ion exchange group had been introduced in Example 1, the diol-type adsorbent material prepared via ring-opening of a glycidil group, and existing adsorbent materials as controls (OASIS WAX and WCX, Waters).

Formulae (1) to (3) below show basic chemical structures of three types of adsorbent materials obtained in Example 1 into which ion exchange groups had been introduced.

TABLE 1
Basic physical properties of the absorbent materials
of the invention and existing absorbent materials

| | | EX1- | EX1- | EX1- | OASIS | OASIS |
|---|---|---|---|---|---|---|
| | EX-1 | SAX | WAX | WCX | WAX | WCX |
| Hydrophobic functional group | DVB | DVB | DVB | DVB | DVB | DVB |
| Ion exchange capacity (meq/g) | — | 0.51 | 0.95 | 0.87 | 0.44 | 0.74 |
| Hydrophobic monomer (%) | 65 | 65 | 65 | 65 | 80 | 80 |
| Hydrophilic monomer (%) | 35 | 35 | 35 | 35 | 20 | 20 |
| Average pore diameter (nm) | 30 | 30 | 30 | 30 | 8 | 8 |
| Specific surface area (m²/g) | 224 | 224 | 224 | 224 | 750 | 750 |
| Particle diameter (μm) | 60 | 60 | 60 | 60 | 60 | 60 |

EX1: Absorbent material as a control of the invention into which no ion exchange group had been introduced
EX1-SAX: Absorbent material into which a quaternary ammonium group had been introduced according to the invention
EX1-WAX: Absorbent material into which a secondary ammonium group had been introduced according to the invention
EX1-WCX: Absorbent material into which a carboxyl group had been introduced according to the invention
OASIS WAX: Absorbent material comprising a tertiary ammonium group introduced into a hydrophobic functional group, DVB
OASIS WCX: Absorbent material comprising a carboxyl group introduced into a hydrophobic functional group, DVB

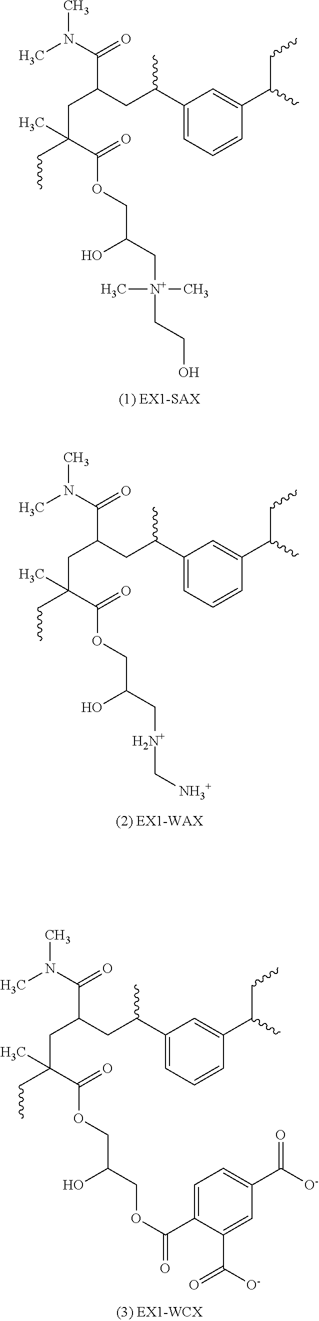

### Example 2

### Effects of Introduction of Ion Exchange Resin

Stainless steel HPLC columns (4.6Φ×150 mm) were slurry-packed with the resin samples obtained in Example 1. A variety of acidic and basic model compounds were used as samples, and hydrophobic retention and ion-exchange interaction effects were compared with those of the adsorbent materials into which no ion exchange group had been introduced (EX1). Ibuprofen, ketoprofen, alprenolol, and quinidine were selected as model compounds. The structures of these model compounds are shown below.

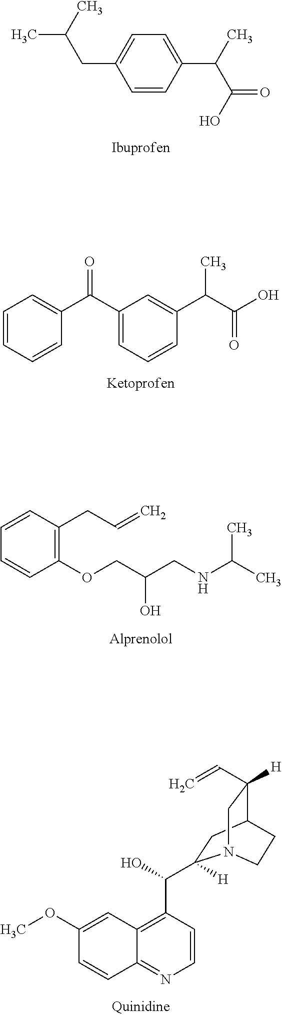

The mobile phase was composed of 10 mM phosphate buffer, MeOH, and NaCl (30:60:10) (pH: 5). The flow rate was 2.0 ml/minute, temperature was 30° C., and the amount of injection was 50 μl. These compounds were injected separately, and detection was carried out at the ultraviolet absorption wavelength adequate for the detection of a relevant model compound.

Table 2 shows a comparison of the durations for retaining model compounds of the adsorbent material into which the ion exchange group had been introduced and the adsorbent material into which no ion exchange group had been introduced (EX1).

TABLE 2
Effects of introduction of ion exchange
group of the invention on retention time

| | Retention time (min) | | | |
|---|---|---|---|---|
| | EX1 | EX1-WAX | EX1-SAX | EX1-WCX |
| Ibuprofen | 1.5 | 16.1 | 5.1 | 8.6 |
| Ketoprofen | 2.9 | 11.7 | 4.6 | 4.0 |
| Alprenolol | 1.6 | 1.2 | 1.1 | 9.7 |
| Quinidine | 1.9 | 1.8 | 1.7 | 47.9 |

The durations for ibuprofen and ketoprofen, which are acidic compounds and undergo anion-exchange reactions, retained in the adsorbent materials to which WAX and SAX had been added were longer than that for the EX1 adsorbent material. This indicates that anion-exchange reactions additionally take place. The prolonged retention time was found to apparently result from dual-mixed-binding mode on each different two sites via hydrophobic interactions and anion-exchange reactions.

Alprenolol and quinidine, which are basic compounds and undergo cation-exchange interactions, exhibited a longer retention time in the adsorbent material to which WCX had been added, compared with the EX1 adsorbent material. This indicates that cation-exchange reactions additionally take place. The prolonged retention time was found to apparently result from dual-mixed-binding mode on each different two sites via hydrophobic interactions and cation-exchange reactions.

### Example 3

### Effects of Amounts of Elution after Trapping Model Compound on Adsorbent Material into which an Ion Exchange Group has been Introduced

In the same manner as in Example 2, retention properties of the absorbent material of the present invention were compared with those of existing adsorbent materials while setting the pH level of the mobile phase to 7. The amount of the eluate was determined based on a peak of a chromatogram obtained in connection with retention of a model compound in the adsorbent material, and flow rate (2 ml/min) was multiplied therewith upon completion of elution of the model compound; i.e., at the time at which the line became identical to the base line (min).

Table 3 shows that, when an EX1-WAX (anion-exchange) adsorbent material was used, the amounts of eluates (i.e., the liquid phase) used for eluting ibuprofen and ketoprofen, which are acidic compounds and perform anionic reactions, were found to be smaller than the existing WAX.

Table 3 shows that, when an EX1-WCX (cation-exchange) adsorbent material was used, the amounts of eluates (i.e., the liquid phase) used for eluting alprenolol and quinidine, which are basic compounds and perform cationic reactions, were found to be smaller than the existing WCX.

When the adsorbent material of the present invention is used, the amount of the eluate can be smaller than that in a case in which an existing ion exchange adsorbent material is used. Therefore, simultaneous concentration, clean up, and fractionation of a target component were found to be rapidly, easily, and effectively carried out

TABLE 3
Amount of eluate when using the absorbent material of the present invention

| | Absorbent | | | |
|---|---|---|---|---|
| | +WAX (anion exchange) | | +WCX (cation exchange) | |
| Compound | Present invention | Existing product | Present invention | Existing product |
| Ibuprofen | 6 to 23 min. | 8 to 28 min. | 0.4 to 2.8 min. | 0.6 to 3.0 min. |
| | 34 ml | 40 ml | 4.8 ml | 4.8 ml |
| Ketoprofen | 4 to 16 min. | 8 to 24 min. | 0.35 to 2.25 min. | 0.6 to 2.9 min. |
| | 24 ml | 32 ml | 3.8 ml | 4.6 ml |
| Alprenolol | 0.8 to 1.75 min. | 1.1 to 3.0 min. | 3 to 16 min. | 5 to 25 min. |
| | 1.9 ml | 3.8 ml | 26 ml | 40 ml |
| Quinidine | 1 to 2.2 min. | 1 to 6 min. | 2 to 25 min. | 5 to 45 min. |
| | 2.4 ml | 10 ml | 46 ml | 80 ml |

All publications, patents, and patent applications cited herein are incorporated herein by reference in their entirety.

1. An adsorbent material comprising a porous material of a polymer compound which is a copolymer obtained via copolymerization of a hydrophobic monomer (A), a hydrophilic monomer (B) capable of undergoing a second-order reaction, and a hydrophilic monomer (C) exhibiting a hydrogen-bonding capacity, and via introduction of an ion exchange group into a repeat unit derived from the hydrophilic monomer (B).

2. The adsorbent material according to claim 1, which comprises an aromatic divinyl compound as the hydrophobic monomer (A) in an amount of at least 50% by mass based on the total amount of monomers.

3. The adsorbent material according to claim 1, which comprises glycidyl methacrylate, glycerin methacrylate, 3-chloro-2-hydroxypropyl methacrylate, 2-hydroxyethyl methacrylate, or 2-chloroethyl methacrylate as the hydrophilic monomer (B) capable of undergoing a second-order reaction in an amount of 20% to 50% by mass based on the total amount of monomers.

4. The adsorbent material according to claim 3, wherein the hydrophilic monomer (B) capable of undergoing a second-order reaction is glycidyl methacrylate.

5. The adsorbent material according to claim 1, which comprises N,N-dimethylacrylamide, N,N-diethylacrylamide, or N-isopropylacrylamide as the hydrophilic monomer (C) exhibiting a hydrogen-bonding capacity in an amount of 5% to 10% by mass based on the total amount of monomers.

6. The adsorbent material according to claim 1, wherein the average pore diameter of the porous material is 15 nm to 50 nm and the specific surface area is 100 to 500 m²/g.

7. The adsorbent material according to claim 1, wherein the porous material has a particulate form and the average particle diameter is 3 μm to 100 μm.

8. The adsorbent material according to claim 1, wherein the ion exchange group is a quaternary ammonium group introduced so that the ion exchange group amount is 0.3 to 0.8 meq, a secondary ammonium group introduced so that the ion exchange group amount is 0.7 to 1.5 meq, or a carboxyl group introduced so that the ion exchange group amount is 0.7 to 1.5 meq.

9. An adsorbent material comprising a porous material having an average pore diameter of 15 nm to 50 nm and a specific surface area of 100 to 500 m²/g of a polymer compound which is a copolymer obtained via copolymerization of a hydrophobic monomer (A), a hydrophilic monomer (B) capable of undergoing a second-order reaction, and a hydrophilic monomer (C) exhibiting a hydrogen-bonding capacity, and via introduction of an ion exchange group into a repeat unit derived from the hydrophilic monomer (B).

10. A solid-phase extraction cartridge comprising the adsorbent material according to claim 1 filled in a container.

11. The solid-phase extraction cartridge according to claim 10, which is used for concentration of a target component and/or removal of contaminants.

12. A method for treating a sample solution comprising performing solid-phase extraction or column switching with the use of the solid-phase extraction cartridge according to claim 10.

13. A method for treating a sample solution containing a target component comprising bringing the sample solution containing a target component into contact with the adsorbent material according to claim 1 under conditions in which the target component is adsorbed to the adsorbent material to isolate, separate, fractionate, clean up, or remove the target component.

14. A method for determining the amount of a target component in a sample solution comprising bringing the sample solution containing a target component into contact with the adsorbent material according to claim 1 under conditions in which the target component is adsorbed to the adsorbent material, washing the adsorbent material to which the target component had adsorbed under conditions in which the target component is released from the adsorbent material, and determining the amount of the target component in the solution resulting from the washing via an analytical technique.

15. The method according to claim 13, wherein the adsorbent material is used in the form of a solid-phase extraction cartridge filled in a container.

16. The method according to claim 13, wherein the target component is a drug, agricultural chemical, herbicide, biomolecule, poison, contaminant, metabolite, or degraded product of any thereof.

17. The method according to claim 13, wherein the sample solution is of blood, blood plasma, urine, spinal fluid, joint fluid, tissue extract, ground water, surface water, drinking water, soil extract, a food material, an extract of a food material, a plant extract, or an extract of a processed food.
